(19) United States
(12) Patent Application Publication
(10) Pub. No.: US 2002/0152206 A1
(43) Pub. Date: Oct. 17, 2002

(54) Synonym-enabled enhancements for matching and registering internet domain names

(75) Inventors: Carl Phillip Gusler, Austin, TX (US); Rick Allen Hamilton II, Charlottesville, VA (US); John Steven Langford, Austin, TX (US)

Correspondence Address: Rudolf O. Siegesmund, Suite 2000, 4627 N. Central Expressway, Dallas, TX, 75205-4022, US

(73) Assignee: International Business Machines Corporation, Armonk, NY (US)

(21) Appl. No.: 09/834,113

(22) Filed: Apr. 12, 2001

(51) Int. Cl. G06F 7/00

(52) U.S. Cl. 707/5

(57) ABSTRACT

A program and method is disclosed for enhancing a domain search by increasing the range of search terms to selected synonyms obtained from a standard thesaurus program. Keywords are compared to the same words in a standard thesaurus program. The domain permutations considered by the search program are expanded to the synonym-enhanced keywords. By not only examining permutations of the explicitly given search terms, but also expanding the search to synonyms, an even greater range of domain names is offered to the user.

### FIELD OF THE INVENTION

The present invention relates to a computerized search for available Internet domain names and, specifically, to the use of primary and secondary search terms where the search terms are extended to include synonyms obtained from a standard thesaurus program.

### BACKGROUND OF THE INVENTION

In the continually expanding Internet environment, organizations seek to register domain names which are relevant to their businesses. Both the act of finding a domain name which is clear and concise, and the act of finding a domain name that will allow consumers to easily find and recall the business's web presence are difficult because of the number of organizations doing business on the Internet. Domain name searches are usually accomplished in one of two ways. First, an interested party seeking a domain name may contact a registration service and request the status of a given domain name. The registration service can provide information on whether that domain name has already been allocated. If the domain name is not available, the interested party may then re-inquire about another domain name, and so forth, until a suitable domain name is found. A second way to accomplish the goal of finding an appropriate domain name is to contract, for a fee, with an agency who will prepare a report to the client with a list of available and suitable domain names.

In 1999, IBM Global Services introduced a third way to find appropriate domain names for businesses or organizations. The innovation permitted a potential domain “purchaser” to automatically enter keywords which could be combined in various patterns. The process combined the convenience of an automated search with the flexibility afforded by a consultation service. Following a simple script, the user enters keywords. These keywords are then arranged in various permutations or subgroups, and automated queries are performed either against the proposed domain names or against a registration agent. Registration agents, such as “register.com,” will then register the selected domain name. Logic to construct the keyword permutations and queries, written in javascript or any other language, delivers functionality, and greatly enhances the “intelligence” associated with domain selection.

What is needed beyond the prior art is a way to further increase the range of possible domain names identified by a computerized search process. Specifically, what is needed beyond the prior art is a way to extend the search to selected synonyms so that a larger range of possible domain names will be identified.

### SUMMARY OF THE INVENTION

The invention which meets the needs identified above is a program and method for enhancing a domain search by increasing the range of search terms to selected synonyms obtained from a standard thesaurus program. Keywords are compared to the same words in a standard thesaurus program. The domain permutations considered by the search program are expanded to the synonym-enhanced keywords. By not only examining permutations of the explicitly given search terms, but also expanding the search to synonyms, an even greater range of domain names is offered to the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is depiction of a distributed data processing system;

FIG. 2 is a depiction of a server computer;

FIG. 3 is a depiction of a client computer;

FIG. 4a is a depiction of a flow chart of the search enhancement process;

FIG. 4b is a continuation of the flow chart of the search enhancement process;

FIG. 5 is a flow chart for a synonym enhanced search program;

FIG. 6 is a flow chart of a subroutine for keyword comparison to an RDB;

FIG. 7 is a flow chart of a delimiter subroutine;

FIG. 8 is a flow chart of a permutation subroutine; and

FIG. 9 is a flow chart of a synonym subroutine.

### DETAILED DESCRIPTION OF THE PREFERRED EMBODIMENT

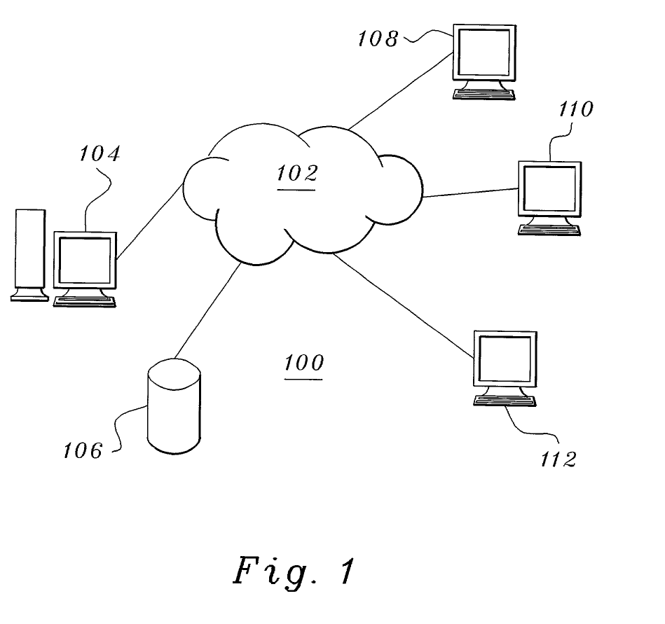

FIG. 1 depicts a pictorial representation of a distributed data processing system in which the present invention may be implemented and is intended as an example, and not as an architectural limitation, for the processes of the present invention. Distributed data processing system 100 is a network of computers which contains a network 102, which is the medium used to provide communications links between various devices and computers connected together within distributed data processing system 100. Network 102 may include permanent connections, such as wire or fiber optic cables, or temporary connections made through telephone connections. In the depicted example, a server 104 is connected to network 102 along with storage unit 106. In addition, clients 108, 110, and 112 also are connected to a network 102. Clients 108, 110, and 112 may be, for example, personal computers or network computers.

For purposes of this application, a network computer is any computer, coupled to a network, which receives a program or other application from another computer coupled to the network. In the depicted example, server 104 provides Web based applications to clients 108, 110 and 112. Clients 108, 110, and 112 are clients to server 104. Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. Distributed data processing system 100 may also be implemented as a number of different types of networks, such as for example, an intranet, a local area network (LAN), or a wide area network (WAN).

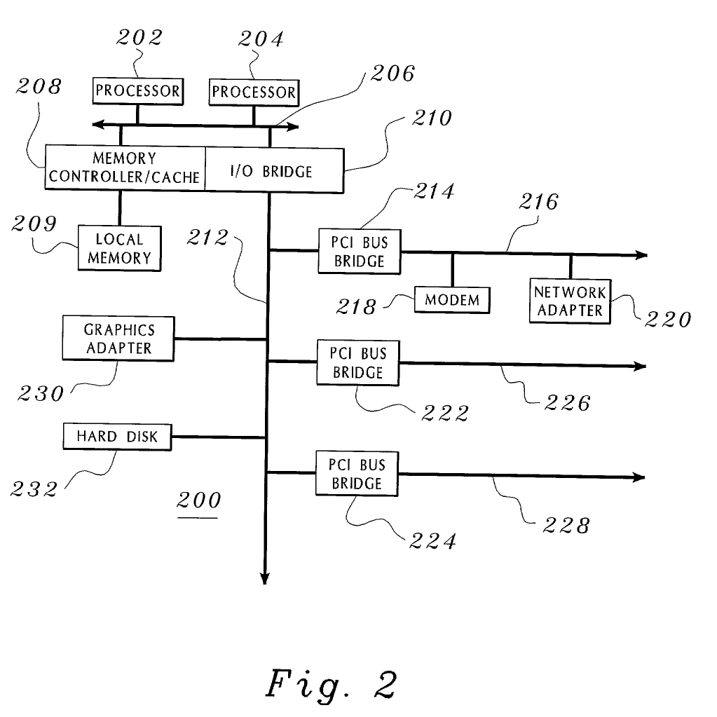

Referring to FIG. 2, a block diagram depicts a data processing system, which may be implemented as a server, such as server 104 in FIG. 1 in accordance with the present invention. Data processing system 200 may be a symmetric multiprocessor (SMP) system including a plurality of processors such as first processor 202 and second processor 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. Peripheral component interconnect (PCI) bus bridge 214 connected to I/O bus 212 provides an interface to first PCI local bus 216. Modem 218 may be connected to first PCI bus local 216. Typical PCI bus implementations will support four PCI expansion slots or add-in connectors. Communications links to network computers 108, 110 and 112 in FIG. 1 may be provided through modem 218 and network adapter 220 connected to first PCI local bus 216 through add-in boards. Additional PCI bus bridges such as second PCI bus bridge 222 and third PCI bus bridge 224 provide interfaces for additional PCI local buses such as second PCI local bus 226 and third PCI local bus 228, from which additional modems or network adapters may be supported. In this manner, server 200 allows connections to multiple network computers. A memory-mapped graphics adapter 230 and hard disk 232 may also be connected to I/O bus 212 as depicted, either directly or indirectly. Those of ordinary skill in the art will appreciate that the hardware depicted in FIG. 2 may vary. For example, other peripheral devices, such as an optical disk drive and the like also may be used in addition or in place of the hardware depicted. The depicted example is not meant to imply architectural limitations with respect to the present invention. The data processing system depicted in FIG. 2 may be, for example, an IBM RISC/System 6000 system, a product of International Business Machines Corporation in Armonk, N.Y., running the Advanced Interactive Executive (AIX) operating system.

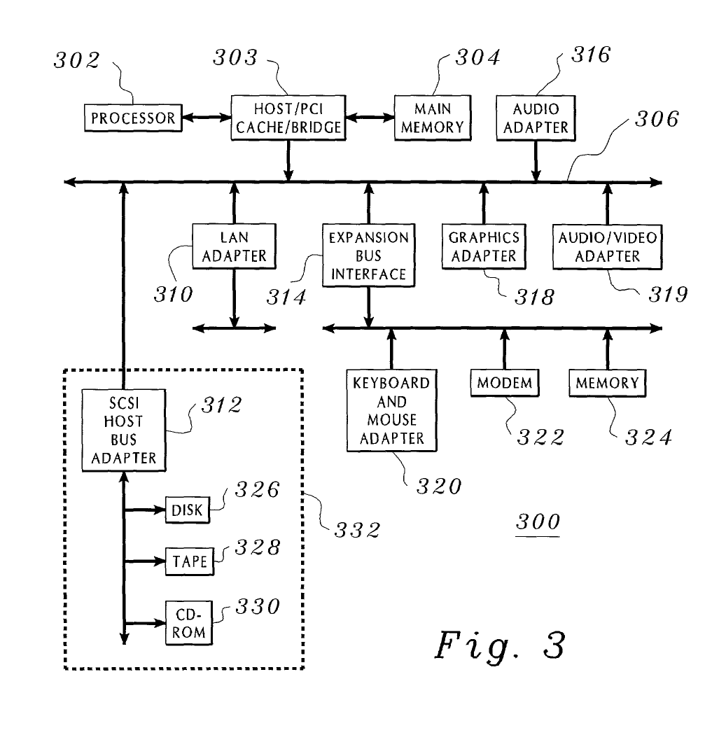

With reference now to FIG. 3, a block diagram illustrates a data processing system in which the invention may be implemented. Data processing system 300 is an example of either a stand-alone computer, if not connected to distributed data processing system 100, or a client computer, if connected to distributed data processing system 100. Data processing system 300 employs a peripheral component interconnect (PCI) local bus architecture. Although the depicted example employs a PCI bus, other bus architectures such as Micro Channel and ISA may be used. Processor 302 and main memory 304 are connected to PCI local bus 306 through PCI bridge 303. PCI bridge 303 also may include an integrated memory controller and cache memory for Processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM 330 in the depicted example. Typical PCI local bus implementations will support three or four PCI expansion slots or add-in connectors. An operating system runs on processor 302 and is used to coordinate and provide control of various components within data processing system 300 in FIG. 3. The operating system may be a commercially available operating system such as OS/2, which is available from International Business Machines Corporation. “OS/2” is a trademark of International Business Machines Corporation. An object oriented programming system, such as Java, may run in conjunction with the operating system and provides calls to the operating system from Java programs or applications executing on data processing system 300. “Java” is a trademark of Sun Microsystems, Incorporated. Instructions for the operating system, the object-oriented operating system, and applications or programs may be located on storage devices, such as hard disk drive 326, and they may be loaded into main memory 304 for execution by processor 302. Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system. For example, data processing system 300, if optionally configured as a network computer, may not include SCSI host bus adapter 312, hard disk drive 326, tape drive 328, and CD-ROM 330, as noted by the box with the dotted line in FIG. 3 denoting optional inclusion. In that case, the computer, to be properly called a client computer, must include some type of network communication interface, such as LAN adapter 310, modem 322, or the like. As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device which is configured with ROM and/or flash ROM in order to provide non-volatile memory for storing operating system files and/or user-generated data. The depicted example in FIG. 3 and above-described examples are not meant to imply architectural limitations with respect to the present invention. It is important to note that while the present invention has been described in the context of a fully functioning data processing system, those of ordinary skill in the art will appreciate that the processes of the present invention are capable of being distributed in a form of a computer readable medium of instructions and a variety of forms and that the present invention applies equally regardless of the particular type of signal bearing media actually used to carry out the distribution. Examples of computer readable media include recordable-type media, such a floppy disc, a hard disk drive, a RAM, and CD-ROMs, and transmission-type media, such as digital and analog communications links.

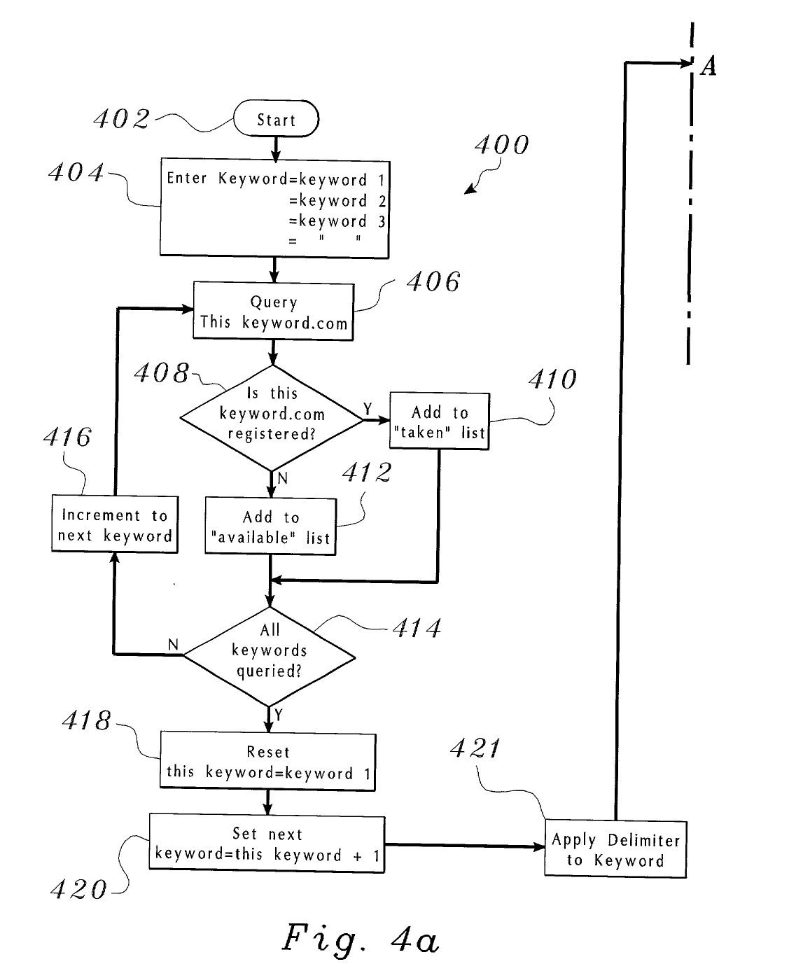

FIGS. 4a and 4b show a flow chart of the search enhancement process that may be implemented. A user selects the type of business for which he is querying. Examples would be commercial (.com) or non-profit (.org). The user starts the process (402) and inputs one or more keywords (404). For example, the user may input a signifying business name, “Johnson”, as keyword 1 and the business category, “Automobiles,” as keyword 2. The user instructs the computer to query the keyword with .com added. The program determines whether keyword.com is registered (408). For example, if keyword 1 entered was “Johnson,” and keyword 2 entered was “Automobile” the program will query as follows: Is “keyword1.com” (johnson.com) registered? (406) Query this first and record its status. The next keyword would be queried. For example, Is “keyword2.com” (automobiles.com) registered? Query this and record its status. Next, a determination is made whether the keywords are registered (408). If a keyword is determined to be registered, it is added to a “taken” list (410). If the keyword is determined not to be taken it is added to an “available” list (412). Next a determination is made whether all keywords have been queried? (414) If all keywords have not been queried, the program increments to the next keyword (416) and returns to step 406 to query the next keyword. If all keywords have been queried, the program sets “this keyword” equal to “keyword 1 (418). Next, the program sets “keyword” equal to “this keyword”+1 (420). Delimiters are applied to “keyword” (421). A delimiter may be either a punctuation symbol or a word that combines a first keyword and a second keyword into a single term that is a combination of the first keyword, the second keyword and the delimiter. A delimiter may be a punctuation symbol such as a “_” “-” or “&.” A delimiter may also be a word such as “and” or “plus.” Delimiters may be set by default or delimiters may be selected by the user prior to performing a search. A determination is made whether this keyword or next keyword.com is registered? (422). If “this keyword” or “this keyword.com” is registered, it is added to the taken list (424). If “this keyword” or “this keyword.com” is not registered, it is added to the “available” list.

Next a determination is made whether the query has been conducted for all delimiters (428). If the query has not been repeated for all delimiters, the program determines whether combinations of the primary and secondary keywords (e.g., johsonautombiles.com) are registered. These combinations are queried and their status is recorded. Note that the invention is not limited to concatenated keywords; rather, various implementations may query concatenations, as well as hyphen-delimited keywords (e.g., johnson-automobiles.com), or other delimiters (e.g. johnson_automobiles.com) without loss of generality. The specifics of the implementation do not detract from the general principles spelled out here. If the queries have been repeated for all delimiters, the program increments to the next keyword (432). The program continues queries for all delimiters and all permutations of keywords (434). Next, queries are made to a thesaurus database using standard technology, to determine synonyms for the secondary words (436). A list is then made of possible “equivalent” keywords. A thesaurus database may be provided or an existing thesaurus program and database may be used. Thesaurus programs and databases are commonplace, as illustrated by their frequent use in word processors and web-driven interfaces (such as “www.thesauraus.com). Next, queries are performed on all synonym permutations and all delimiters (438). A permutation is an ordered arrangement of a given number of different elements selected from a set. The set in this application may consist of one or more of the following: keywords, delimiters, synonyms and combinations. In other words, combinations of synonym enhanced keywords, are queried in the same way the combinations of step 5 above were queried. Subsequent combinations might read “johnsoncars.com,” “johnsonmotorcars.com,” “johnsonautomotive.com,” and so forth. While no attempt is made at this point to choose the most aesthetically-pleasing name, the intention of providing users with the widest range of choices for available domain name is met.

The program then supplies the user with lists of both available and taken demands (440). The compiled list is then presented to the user, with an option to register the domain immediately, for appropriate transaction fees. The program determines whether the user desires to register a domain name (442). If the user desires to register a domain name, then the program performs the registration (446) and the program ends (448).

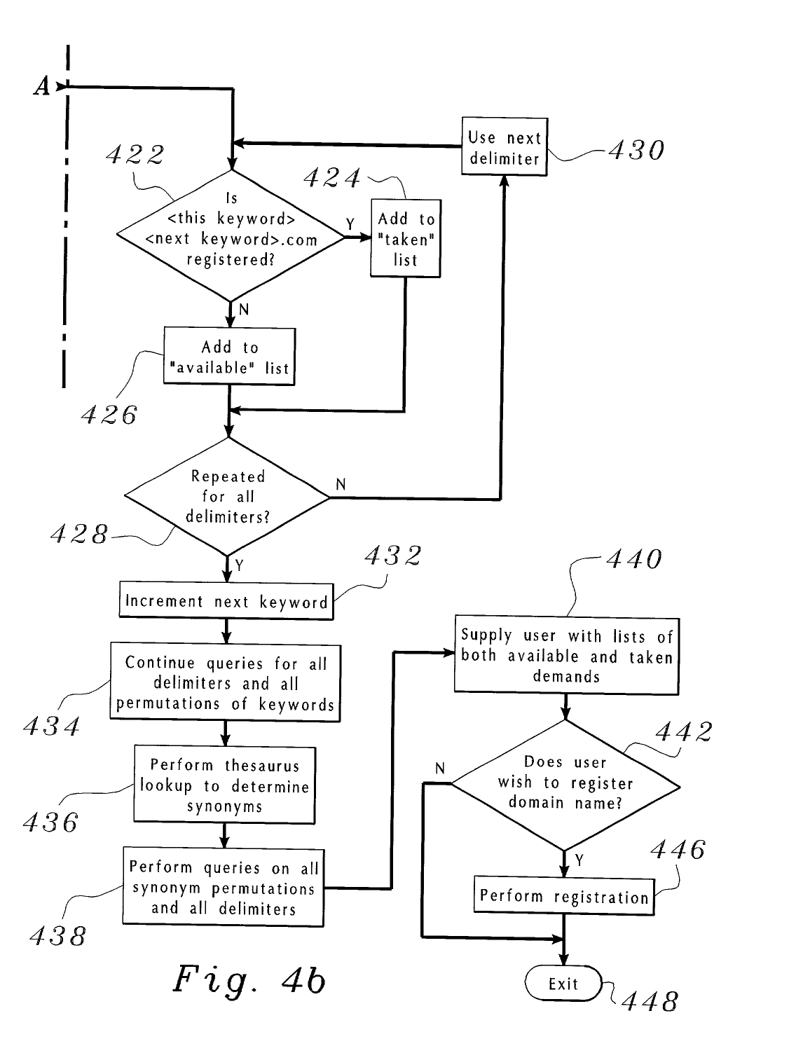

FIG. 5 depicts program 500 to implement synonym enhanced domain name search. The following terms shall be used: K(N) is the basic routine comparing a key word to a Registration Data Base (RDB); K(J) is the Delimiter subroutine where there are J delimiters; K(P) is the Permutation subroutine where there are P permutations; K(S) is the Synonym subroutine where there are S synonyms; L1 is the list of all available domain names; and L2 is the list of all taken domain names. The RDB may be present on the same physical device as a search program, or the RDB may be located on a physical device remote from the search program and be searchable via a netowrd coupling the search program to the RDB.

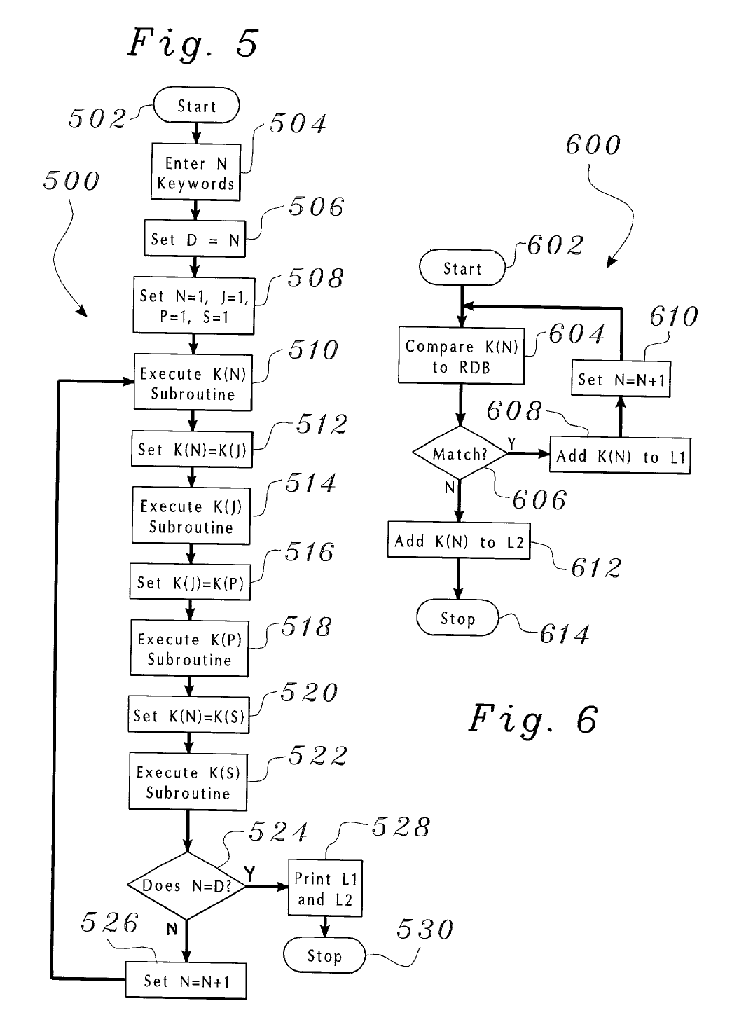

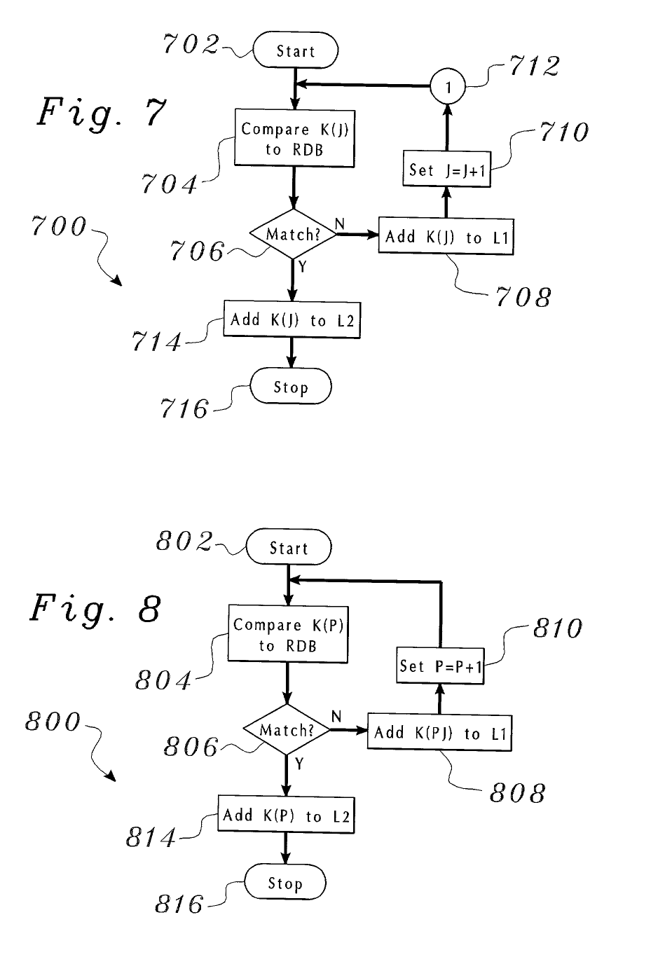

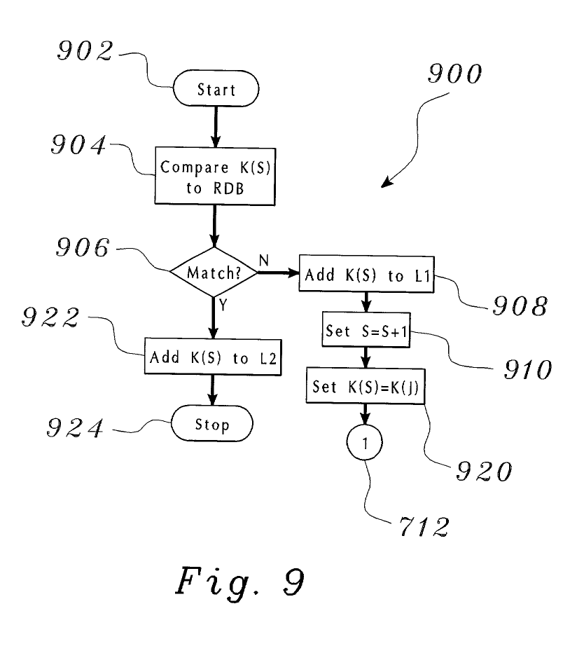

Program 500 starts (502) and Keywords are entered (504). Any number of keywords can be entered and the number of keywords entered is represented by N. D is set equal to N (506). The following parameters are initialized: N is set equal to 1; J is set equal to 1; P is set equal to 1; and S is set equal to 1 (508). Next, the K(N) subroutine is executed (510). The K(N) subroutine is shown in FIG. 6. After the K(N) subroutine is completed, K(N) is set equal to K(J) (512). The K(J) subroutine is then executed (514). The K(J) subroutine is shown in FIG. 7. After the K(J) subroutine is completed, K(J) is set equal to K(P) (516). The K(P) subroutine is then executed (518). The K(P) subroutine is shown in FIG. 8. Next K(P) is set equal to K(S) (520). The K(S) subroutine is executed (522). The K(S) subroutine is shown in FIG. 9. After execution of the K(S) subroutine, program 500 determines whether N is equal to D (524). If N is equal to D, then L1 and L2 are printed (528) and program 500 stops (530). If N does not equal D, then N is set equal to N plus 1 (526) and program 500 returns to step 510.

FIG. 6 shows K(N) subroutine 600. K(N) subroutine 600 starts (602) and K(N) is compared to the Reference Data Base (RDB) 604. Since N has been initialized to 1 in program 500, the comparison will be between the first keyword entered in program 500 and the RDB. A determination is made as to whether a match has been made between K(N) and the RDB (606). The first match will be for K(1). If a match has been made, then K(N) is added to L2 and K(N) subroutine stops. If a match is not made between K(N) and the RDB, K(N) is added to L1 (608). Next, N is set equal to N plus 1 (610) and K(N) subroutine 600 returns to step 604 where K(2), or the second keyword entered in program 500 is compared to the RDB.

FIG. 7 shows K(J) subroutine 700. K(J) subroutine 700 uses delimiters to compare keywords entered in program 500 to the RDB. Since J has been initialized to 1, K(J) or K(1) is compared to the RDB (704). A determination is made as to whether or not a match has been made (706). If a determination is made that a match has been made, then K(J) is added to L2 (714) and K(J) subroutine 700 stops (716). If a determination is made that a match has not been made, K(J) is added to L1 (708) and J is set equal to J plus 1 (710). K(J) subroutine 700 then returns to step 704, where K(2) is compared to RDB. Connector 1 (712) is located between the start step (702) and the comparison step 704 and is the interface connection with K(S) subroutine 900 (see FIG. 9).

FIG. 8 shows K(P) subroutine 800. K(P) subroutine 800 starts (802) and K(P) is compared to RDB (804). P has been initialized to 1 by program 500, so K(1) is compared to RDB. The number of permutations entered is P. A determination is made as to whether a match has been made between K(1) and RDB. If a match has been made, then K(1) is added to L2 and K(P) subroutine 800 stops. If a determination is made that a match has not been made, then K(P) is added to L1 (808) and P is set equal to P plus 1 (810). K(P) subroutine 800 then returns to step 804.

FIG. 9 depicts K(S) subroutine 900. K(S) subroutine 900 compares synonyms for keywords entered in program 500 to the RDB. K(S) is compared to RDB (904). A determination is made as to whether a match has been made (906). If a match has been made, then K(S) is added to L2 (922) and K(S) subroutine 900 stops. If a determination is made that a match has not occurred, K(S) is added to L1 (908). Next S is set equal to S plus 1 (910) and K(S) is set equal to K(J) (920) and K(S) subroutine 900 interfaces with connector 712 and goes to step 704 of K(J) subroutine 700 within program 500.

In the preferred embodiment, the above described program would be available through provider web sites. Whether a hyphen-delimited query is made before an underscore-delimited query is of no importance. Rather, the offering of Internet domain registration based upon search terms pertinent to a given organization's mission, goals, name, and possible location coupled with an expanded search to include synonyms results in more options for the intended registrant.

The advantages provided by the present invention should be apparent in light of the detailed description provided above. The description of the present invention has been presented for purposes of illustration and description, but is not limited to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed:

1. A programmable apparatus for generating a list of available Internet domain names comprising:
a computer having a memory;
a plurality of keywords in said memory;
an RDB in said memory;
a thesaurus program in said memory; and
a program in the memory for causing the computer to identify a synonym for each of the keywords, to compare the synonyms to the RDB, and to determine if a match exists between each of the keywords, each of the synonyms and a corresponding word or combination in the RDB.

2. The programmable apparatus of claim 1 wherein the program further comprises a subroutine for creating a combination of a first keyword and a second keyword, and comparing the combination to the RDB to determine whether a match exists.

3. The programmable apparatus of claim 1 wherein the program further comprises a subroutine for creating a combination of a first keyword, a second keyword and a delimiter and comparing the combination to the RDB to determine whether a match exists.

4. The programmable apparatus of claim 1 wherein the program further comprises a subroutine for creating a plurality of permutations of a first keyword, a second keyword, a delimiter and a synonym, and then comparing each of the plurality of permutations to the RDB to determine whether a match exists.

5. The programmable apparatus of claim 1 wherein the program further comprises instruction to pint a first list of available Internet domain names.

6. The programmable apparatus of claim 1 wherein the program further comprises instruction to pint a second list of taken Internet domain names.

7. A method for generating a list of available Internet domain names comprising the steps of:
entering a keyword;
identifying synonyms for the keyword; and
determining whether each synonym matches a word in the RDB.

8. The method of claim 7 further comprising:
responsive to a match, adding the synonym to a taken list; and
responsive to a determination that there is no match, adding the synonym to an available list.

9. The method of claim 7 further comprising the steps of:
comparing the keyword to the RDB;
determining whether the keyword matches a word in the RDB;
responsive to a match, adding the keyword to a taken list; and
responsive to a determination that there is no match, adding the keyword to an available list.

10. The method of claim 7 further comprising the steps of:
entering a second keyword;
comparing the second keyword to the RDB;
determining whether the second keyword matches a word in the RDB;
responsive to a match, adding the second keyword to a taken list;
responsive to a determination that there is no match, adding the second keyword to an available list;
creating a plurality of combinations of the first keyword and the second keyword;
comparing each the combinations to the RDB;
responsive to a matched combination, adding the matched combination to a taken list; and
responsive to a determination that there is an unmatched combination, adding the unmatched combination to an available list.

11. The method of claim 7 further comprising the steps of:
entering a second keyword;
comparing the second keyword to the RDB;
determining whether the second keyword matches a word in the RDB;
responsive to a match, adding the second keyword to a taken list;
responsive to a determination that there is no match, adding the second keyword to an available list;
creating a plurality of combinations of the first keyword and the second keyword;
comparing each the combinations to the RDB;
responsive to a matched combination, adding the matched combination to a taken list;
responsive to a determination that there is an unmatched combination, adding the unmatched combination to an available list;
creating a plurality of permutations of the first key word, the second key word, and a delimiter;
comparing each of the permutations to the RDB:
responsive to a matched permutation, adding the matched permutation to a taken list; and
responsive to a determination that there is an unmatched permutation, adding the unmatched permutation to an available list;

12. A computer readable memory for causing a computer to compile a list of available Internet domain names comprising:
a computer readable storage medium;
an RDB accessible to said computer;
a computer program stored in said storage medium; wherein the storage medium, so configured by said computer program, causes the computer to perform the following steps:
receive N Keywords;
set D=N;
set N=1, J=1, P=1, and S=1;
execute a K(N) subroutine;
set K(N)=K(J);
execute K(J) subroutine;
set K(J)=K(P);
execute a K(P) subroutine;
set K(N)=K(S);
execute K(S) subroutine;
determine whether N=D;
responsive to a determination that N=D, printing L1 and L2 and stopping;
responsive to a determination that N does not equal D, setting N=N+1 and returning to the step of executing K(N) subroutine; and
wherein L1 is a list of available names and L2 is a list of non-available names.

13. The computer readable medium of claim 12 wherein K(N) subroutine comprises the steps of
comparing K(N) to RDB;
determining whether a match exists;
responsive to a determination that a match exists, adding K(N) to L1; and
responsive to a determination that a match exists, adding K(N) to L1, setting N=N+1 and returning to the step of comparing K(N) to the RDB.

14. The computer readable medium of claim 12 wherein the K(J) subroutine comprises the steps of:
comparing K(J) to RDB;
determining whether a match exists;
responsive to a determination that a match exists, adding K(J) to L1;
responsive to a determination that a match exists, adding K(J) to L1, setting J=J+1 and returning to the step of comparing K(J) to the RDB.

15. The computer readable medium of claim 12 wherein the K(P) subroutine comprises the steps of:
comparing K(P) to RDB;
determining whether a match exists;
responsive to a determination that a match exists, adding K(P) to L1;
responsive to a determination that a match exists, adding K(P) to L1, setting P=P+1 and returning to the step of comparing K(P) to the RDB.

16. The computer readable medium of claim 12 wherein the K(S) subroutine comprises the steps of:
comparing K(S) to RDB;
determining whether a match exists;
responsive to a determination that a match exists, adding K(S) to L2;
responsive to a determination that a match does not exist, adding K(S) to L1, setting S=S+1, setting K(S)=to K(J) and returning to the step of comparing K(J) to the RDB.

17. A programmable apparatus for generating a list of available Internet domain names comprising:
programmable hardware comprising;
a server computer; and
a client computer;
a database;
a network connecting the server computer, the client computer and the data base;
a first program installed on said server computer;
a thesaurus program installed on said server computer;
a plurality of keywords entered into a client computer; and
a program installed in said client computer for causing the client computer to access the thesaurus program and to identify a synonym for each of the keywords, to access the database, to compare the synonyms to the database, and to determine if a match exists between each of the keywords, each of the synonyms and a corresponding word or combination in the database.

18. The programmable apparatus of claim 1 wherein the program further comprises a subroutine for creating a combination of a first keyword and a second keyword, and then comparing the combination to the database to determine whether a match exists.

19. The programmable apparatus of claim 1 wherein the program further comprises a subroutine for creating a combination of a first keyword, a second keyword and a delimiter and then comparing the combination to the database to determine whether a match exists.

20. The programmable apparatus of claim 1 wherein the program further comprises a subroutine for creating a plurality of permutations of a first keyword, a second keyword, a delimiter and a synonym, and then comparing each of the plurality of permutations to the database to determine whether a match exists.
